(19) United States
(12) Patent Application Publication
(10) Pub. No.: US 2024/0326887 A1
(43) Pub. Date: Oct. 3, 2024

(54) Folding A-Frame Cart

(71) Applicant: Anthony Browne, Pound Ridge, NY (US)

(72) Inventor: Anthony Browne, Pound Ridge, NY (US)

(21) Appl. No.: 18/620,452

(22) Filed: Mar. 28, 2024

Related U.S. Application Data
(60) Provisional application No. 63/492,545, filed on Mar. 28, 2023.

(51) Int. Cl. B62B 3/02; B62B 3/10; B62B 5/04

(52) U.S. Cl. CPC B62B 3/02; B62B 3/108; B62B 5/0433; B62B 5/0485

(57) ABSTRACT

A transportation apparatus, having an A-frame including a first subframe, second subframe, third subframe, and a fourth subframe; wherein the first and second subframes form a base of the A-frame, and the third and fourth subframes form sides of the A-frame; including a locking mechanism for transitioning the transportation apparatus between an expanded state and a collapsed state, the locking mechanism adjustable between an engaged state and a disengaged state; and wherein the folding transportation apparatus includes an A-frame mounted to a base, the base having at least one wheel, and a second frame rotatably mounted to the A-frame.

### TECHNICAL FIELD

The present invention relates to a wheeled vehicle for the transportation of primarily flat goods capable of being operated by a single human and capable of folding into a compact shape for storage and transport.

### BACKGROUND

Transportation of flat goods, such as art, drywall, plywood, tables, televisions, glass and mirrors, scaffolding, windows, and other such flat goods is a necessary and common need. Moving such objects by hand is often difficult, regardless of the weight of the flat good, as the geometry can make supporting the flat good with two hands extremely difficult or impossible, and maneuvering the flat good through doorways and other interior building features can be similarly difficult or impossible.

Presently, there exist specialized carts for the transportation of flat goods. Flat goods can include art, drywall or plywood, tables, televisions, glass and mirrors, scaffolding, and windows. Such specialized carts are often rigid, heavy, cumbersome, and offer limited or no features which accommodate flat goods other than those the specialized cart was designed for. Users of existing specialized carts often face challenges moving the specialized cart itself, such as when the user needs to carry it up a flight of stairs, load and unload the specialized cart into a delivery or personal vehicle, or store the specialized cart for later use. Existing specialized carts also lack storage compartments for small tools, parts, and other installation equipment and supplies. It is therefore desirable to have improvements in carts designed for handling flat goods.

The present invention aims to resolve these issues by means of a series of hinges allowing the cart to become more compact and easier to handle. The cart is comprised of five subframe sections with hinges joining each subframe section. Each of the subframe sections moves to a new relative position when the cart transforms in shape. A pair of latches lock the cart in both its open position and folded position. An integrated tray is included for user storage of tools or supplies, and further provides a work surface.

### SUMMARY

The present invention offers a superior cart design for the transportation of flat goods.

In one aspect of the present invention, the cart folds and locks into said folded position to become easier to lift and transport when not in use, and reduces the volume of space required for storage of the cart.

In another aspect of the present invention, the cart incorporates multiple ergonomic handholds allowing for a user to more easily and efficiently operate and steer the cart.

In another aspect of the present invention, the cart features multiple places to secure cargo straps or other load retention devices to secure flat goods.

In another aspect of the present invention, the cart is lightweight allowing for easier use, transportation, and increased load-carrying capacity for a given wheel load rating.

In another aspect of the present invention, the cart incorporates a folding tray and storage containers therein.

In another aspect of the present invention, the cart incorporates an extended handle increasing the leverage a user has over the cart about its steering axis and thereby making the cart easier to steer.

In another aspect of the present invention, the cart features angled subframe members preventing flat goods from falling or sliding off and reducing the tension applied by a cargo strap necessary to prevent such falling or sliding off of flat goods.

In another aspect of the present invention, the cart features rounded corners and edges to prevent or lessen damage caused to objects near the cart, such as walls, doorways, and other interior features.

### BRIEF DESCRIPTION OF THE DRAWINGS

FIG. 1 is an isometric front view of the cart in the open position with the tray in the open position.

FIG. 2 is a front view of the cart in the open position.

FIG. 3 is a side view of the cart in the open position with the tray in the open position.

FIG. 4 is an isometric rear view of the cart in the open position with the tray in the open position.

FIG. 5 is an isometric front view of the cart in the open position with the tray in the open position, with exploded details of latch components, caster wheel components, and hinge components.

FIG. 5A is a view of Detail A in FIG. 5.

FIG. 5B is a view of Detail B in FIG. 5.

FIG. 6 is an isometric front view of the cart in the folded position with the tray in the folded position.

### DETAILED DESCRIPTION

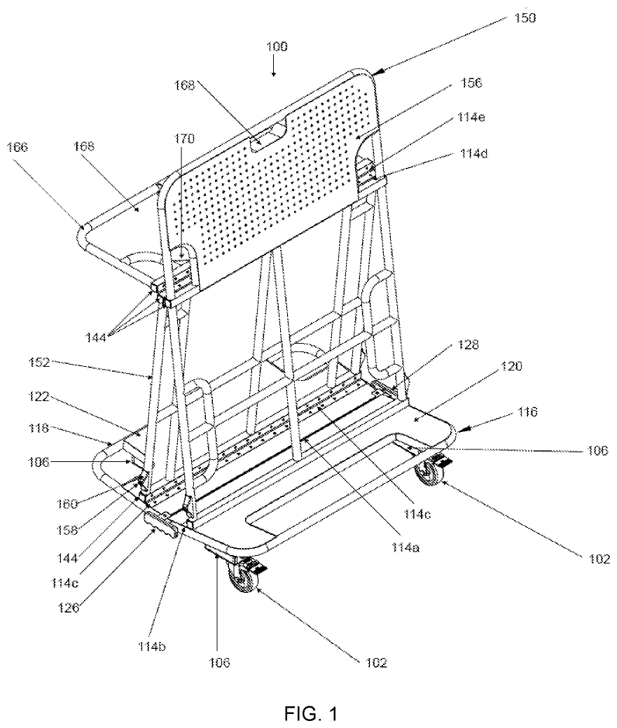

FIG. 1 is a front isometric view of the cart 100 in the open position with the integrated tray 164 in the open position. The cart 100 has an A-frame design, with one side of the A-frame provided by subframe 152 and the other side of the A-frame provided by subframe 150. Subframes 150, 152 may be formed from round or square tube which is bent and cut to shape with welded joints, or other means known in the art. Subframes 150, 152 may be constructed from aluminum or steel, plastic, fiber-reinforced materials such as fiberglass, or other materials. The structure of each subframe 150, 152 may be a web form generally rectangular in shape with a generally flat surface across the tubes providing a consistent and well-supported plane on which goods can lean while further reducing weight and allowing for non-flat goods to be well-supported where protrusions on the goods may pass through the web form of the subframe 150, 152. Subframes 150, 152 may be identical in construction where no integrated tray 164 is provided or an integrated tray 164 is provided on each subframe.

Subframe 150, depicted with an integrated folding tray 164 in the deployed position, is coupled to sheet 120 via hinge 114b and is coupled to subframe 152 via hinge 114d. Subframe 150 has a rectangular shape which provides a body on which goods can lean and a structure to which left latch 126 and right latch 128 can mate via a tapered pin 130 when cart 100 is in the folded position. Sheet 156 is coupled to subframe 150 across the top of the subframe, across a portion of the sides of the subframe, and to the midsection of the subframe where hinge 114d is mounted. Sheet 156 is flat and rectangular in shape with rounded corners on opposite corners of a long edge, and at the center of that long edge is a rectangular cutout. Along the perimeter of the cutout on sheet 156 is bracket 162. Sheet 156 may be formed from perforated or solid sheet, a casting or molding, or other materials. Sheet 156 may be constructed from aluminum or steel, plastic, fiber-reinforced materials such as fiberglass, or other materials. Plugs 144, square in shape, are inserted into the open tubing ends of subframe 150 to conceal the cavity and prevent debris from entering the subframe. Plugs 144 are present on other subframes discussed below and serve the same purpose in those applications. Subframe 150 is coupled to sheet 120 via hinge 114b and to subframe 152 via hinge 114d. Subframe 150 further includes handhold 150a.

Subframe 152, like subframe 150, is rectangular in shape and provides a body on which goods can lean and a structure to which left latch 126 and right latch 128 can mate via a tapered pin 130 when cart 100 is in the folded position. Subframe 152 is coupled at the bottom edge to sheet 122 via hinge 114c, and at the upper inside edge to subframe 150 via hinge 114d, and at the top edge to subframe 166 via hinge 114e.

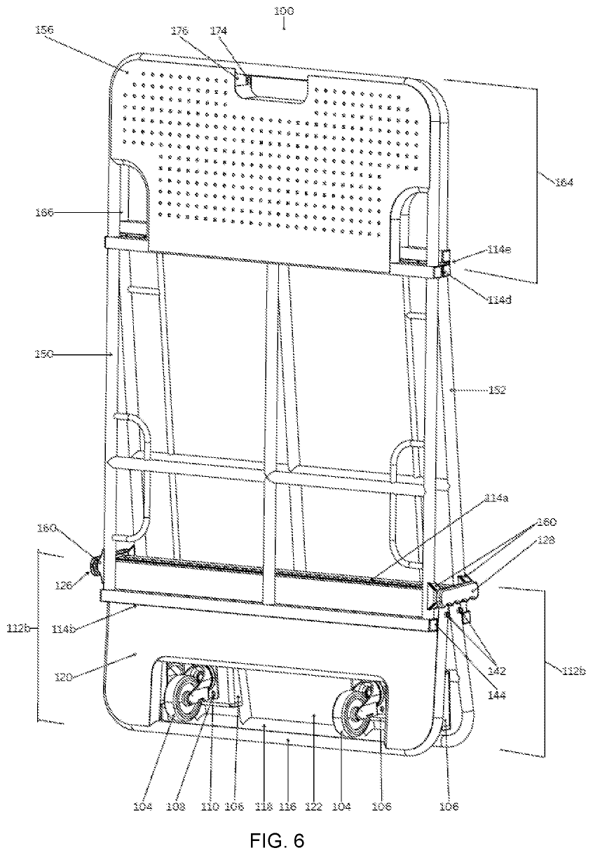

Platform 112a is comprised of subframe 116, two brackets 106, two bushings 142, two plugs 144 capping open ends of the subframe 116, and sheet 120. Bushing tube 142 is tubular in shape and is installed in pairs on both ends of subframe 116 and positioned such that each tapered pin 130 mates with a bushing tube 142 when cart 100 is in the open and locked position. A rubber strip 164 is affixed to the full length of the sides of subframe 116 where it abuts sheet 120 to dampen vibration when the cart 100 is in use. Platform 112a supports the weight of the goods being carried and is the structure onto which, along with brackets 106, casters 102 are attached. Tapered pin 130 mates to lock platform 112a and platform 112b in a fixed position and relative angle along the axis of hinge 114a by which platform 112a and platform 112b are coupled. Platform 112a is coupled lengthwise at a midpoint of sheet 120 to subframe 150 via hinge 114b, a set of screws 136 and a set of bolts 148. There is a rectangular cutout in platform 112a along the edge opposite the hinged edge through which casters 104 pass when cart 100 is in the folded position, as depicted in FIG. 6.

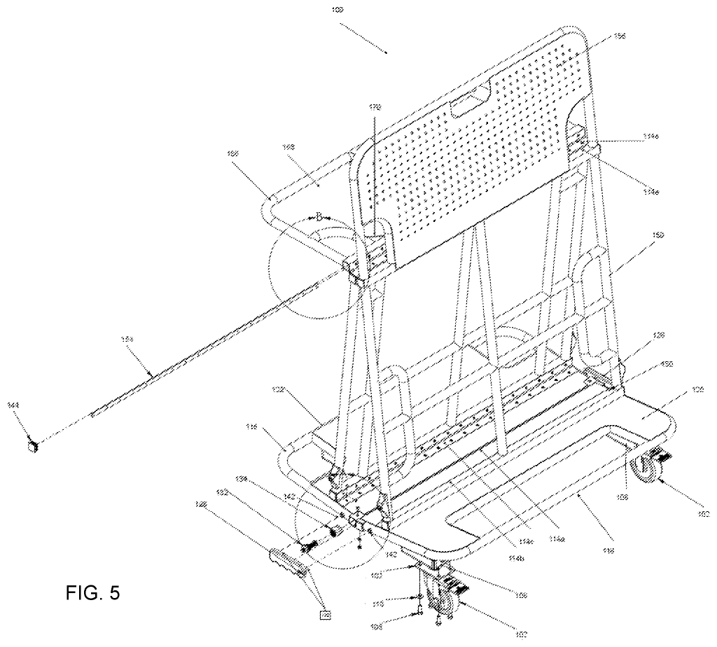

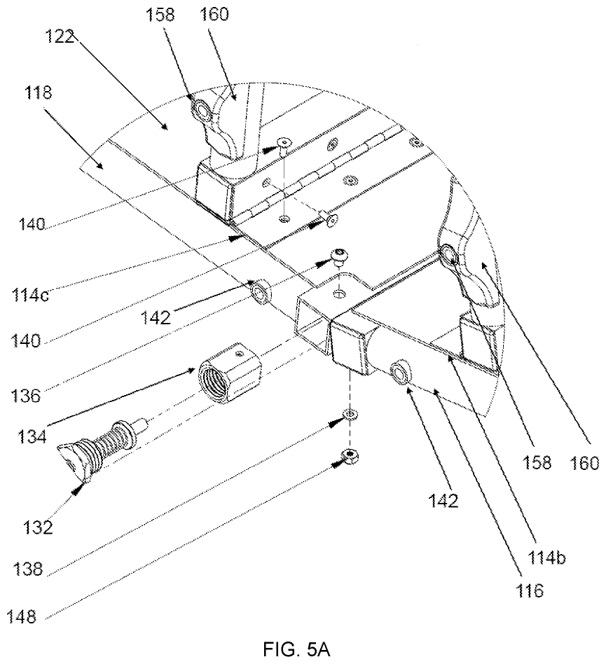

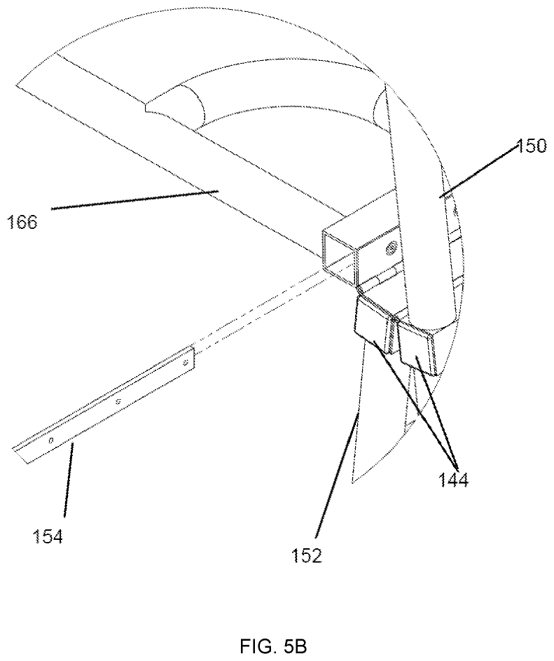

Caster 102 has rubber wheels which swivel and a mounting plate. Two of caster 102 along with two of caster 104 allow the cart to roll and turn. Each mounts to a bracket 106 via a set of bolts 108 and a set of washers 110, as depicted in FIG. 5.

Bracket 106 has a box shape with one side taller than the opposite, forming angled edges on the adjacent sides. It serves as a connection between caster 102 and subframe 116, as well as between caster 104 and subframe 118 as discussed below. The angled shape of bracket 106 makes caster 102, as well as caster 104, perpendicular to the X-Y plane by offsetting the upturned angle of subframe 116, as well as the upturned angle of subframe 118 as discussed below.

Bolt 108 in sets of four (4) hold each of caster 102 to their respective bracket 106 by mating with threads in bracket 106. Washer 110 provides load distribution and prevents loosening for each bolt 108.

Platform 112b is comprised of subframe 118, two brackets 106, two bushings 142, two plugs 144 capping open ends of the subframe 118, two pull pin housings 132, and sheet 122. Bushing tube 142 is tubular in shape and is installed in pairs on both ends of subframe 118 and positioned such that each tapered pin 130 mates with a bushing tube 142 when cart 100 is in the open and locked position. A rubber strip 164 is affixed to the full length of the sides of subframe 118 where it abuts sheet 122 to dampen vibration when the cart 100 is in use. Platform 112b supports the weight of the goods being carried and is the structure onto which, along with brackets 106, casters 104 are attached. Tapered pin 130 mates to lock platform 112b and platform 112a in a fixed position and relative angle along the axis of hinge 114a by which platform 112b and platform 112a are coupled. Platform 112b is coupled lengthwise at a midpoint of sheet 122 to subframe 152 via hinge 114c, a set of screws 136 and a set of bolts 148. There is a rectangular cutout in platform 112c at each of the corners of the edge opposite the hinged edge through which casters 102 pass when cart 100 is in the folded position, as depicted in FIG. 6.

Caster 104 has rubber wheels which swivel and a mounting plate. Two of caster 104 along with two of caster 102 allow the cart to roll and turn. Each mounts to a bracket 106 via a set of bolts 108 and a set of washers 110, as depicted in FIG. 5.

Bolt 108 in sets of four (4) holds each caster 104 to their respective bracket 106 by mating to threads in bracket 106.

Hinge 114a is a continuous hinge of length equal to subframe 116 and subframe 118 and couples the two via multiple of screws 140 and nut bar 154. Hinge 114b is a continuous hinge of length equal to subframe 116 and equal to the width of subframe 150. It couples the two subframes via multiple of screws 140 and nuts 148 at the bottom edge of subframe 150 and a midpoint of subframe 116.

Subframe 116 is rectangular in shape with two rounded corners and is covered on one flat side by sheet 120 and on the other flat side two of brackets 106 are affixed. Subframe 116 provides structural support for a load. Subframe 116 is coupled to subframe 118 on a long edge via hinge 114a. A bushing tube 142 is installed in subframe 116 at both short ends where a tapered pin 130 mates to each.

Sheet 120 has a rectangular, flat shape with two rounded corners on a long edge and a smaller rectangle cutout in the middle of that same edge. Sheet 120 is attached to subframe 116 and provides a surface on which goods rest as well as a point at which hinge 114b is affixed.

Subframe 118 is rectangular in shape with two rounded corners of a long edge and is covered on one flat side by sheet 122 and on the other flat side two of brackets 106 are affixed. Subframe 118 provides structural support for a load. Subframe 118 is coupled to subframe 116 on a long edge via hinge 114a. A pull pin housing 132 is installed within the tubing at the corner adjacent the edge to which hinge 114a is affixed. A bushing tube 142 is installed in both short edges of subframe 118 where a tapered pin 130 mates with each.

Sheet 122 has a rectangular, flat shape with two rounded corners on a long edge with a smaller rectangle cutout at each rounded corner. Sheet 122 is affixed to subframe 118 and provides a surface on which goods rest as well as a point at which hinge 114c is joined.

Hinge 114c is a continuous hinge of length equal to subframe 118 and subframe 152 and couples the two subframes via multiple of screws 140. Hinge 114d is a continuous hinge of length equal to subframe 150 and subframe 152 and couples the two via multiple of screws 140 at the top edge of subframe 152 and a midpoint of subframe 152.

Hinge 114e is a continuous hinge of length equal to subframe 152 and subframe 156 and couples the two subframes via multiple of screws 140 at the top edge of subframe 152 and the longest edge of subframe 150.

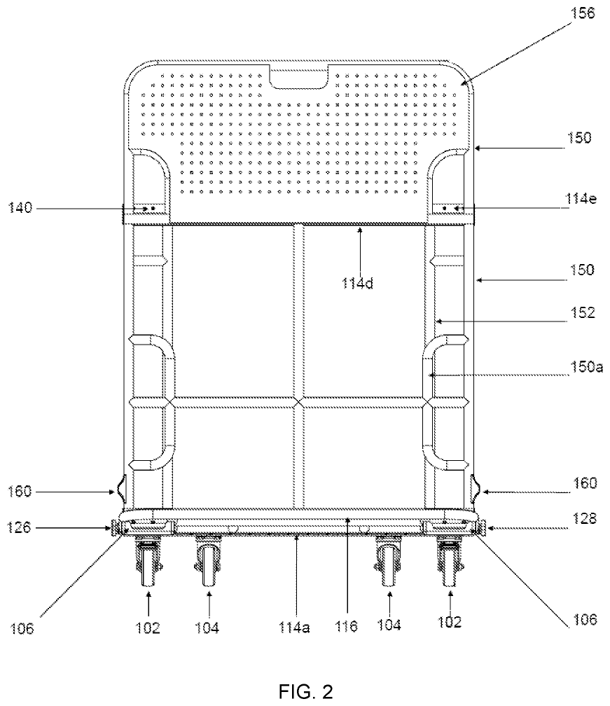

FIG. 2 is a front view of the cart in the open position.

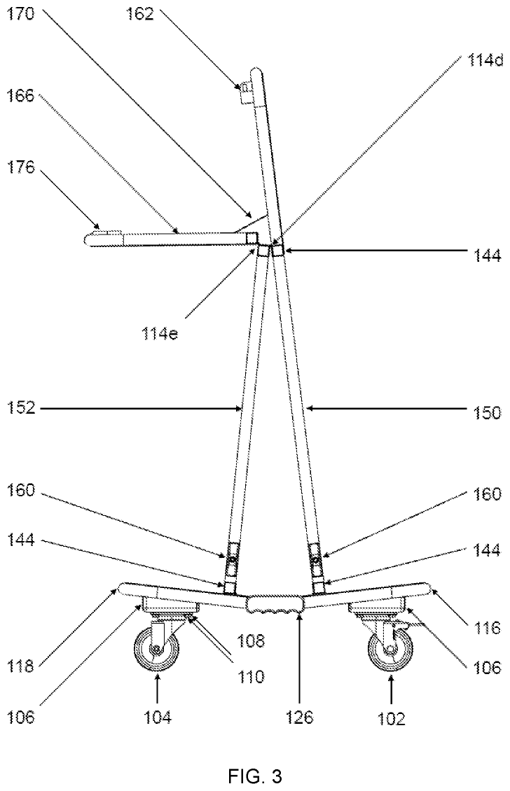

FIG. 3 is a side view of the cart 100 in the open or expanded position with the tray 164 in the open position.

Cart 100 has a base which is equally divided lengthwise into two platforms provided by platform 112b (including subframe 118) and platform 112a (including subframe 118), both of which are coupled together and pivot via hinge 114a. Cart 100 also hinges where the upright structures provided by subframe 150 and subframe 152 meet the base via hinge 114b (joining subframe 150 and platform 112a) and hinge 114c (joining subframe 152 and platform 112b). Subframe 150 and subframe 152 are joined at their upper edge by hinge 114d. The inclusion of hinges 114a, 114b, 114c, 114d allow the cart 100 to fold into a compact shape for handling, transportation, and storage.

The strength-to-weight ration of cart 100 is enhanced over the prior art by the truss structure formed by platforms 112a, 112b and subframes 150, 152 and the point unions provided by the hinges 114a, 114b, 114c, 114d.

As discussed in greater detail above and below, the cart 100 has an integrated tray 164 which is useful for storage of work orders and other documents, hand tools, hardware, securement straps, and safety equipment. Tray 164, when in the open position, provides a leverage means by which a user may steer the cart 100, particularly useful when the flat good loaded on the cart 100 is wide or large enough to obscure the handholds.

Casters 102 are offset from casters 104 where the casters are attached to their respective subframes 116, 118 such that when cart 100 is folded or in the collapsed position the casters do not occlude the path of each other as platform 112a and platform 112b fold inward along the axis of hinge 114a. Casters 104 are inset in relation to casters 104 where the casters are attached to their respective subframes 116, 118 such that when the cart 100 is rolled it travels in a straight line.

A gap is present between platform 112a and platform 112b where they are coupled by hinge 114a. This gap allows hinge 114a to travel beyond 180 degrees in the open or expanded position, as shown in FIG. 1, before platform 112a and platform 112b come into contact. An obtuse angle is formed between the hinge 114a leaves and a corresponding obtuse angle is formed on the topside of platform 112a and platform 112b, with each platform being one leg of the angle. On the underside of platform 112a and platform 112b there is a complementary acute angle formed in relation to the floor upon which the cart 100 is operated. The acute angles between the floor and the respective platform 112a, 112b makes those platforms relatively “upturned” to keep flat goods from sliding off the long edge of the respective platform.

Brackets 106 have angled sides to counter the angle of platforms 112a, 112b and allow the casters 102, 104 to have a steering axis normal to the floor on which the cart 100 is operated. Without the angled sides of brackets 106, the cart 100 would not roll easily or straight. The complementary angles on the mounting face of brackets 106 permit the “upturned” angles of platforms 112a, 112b.

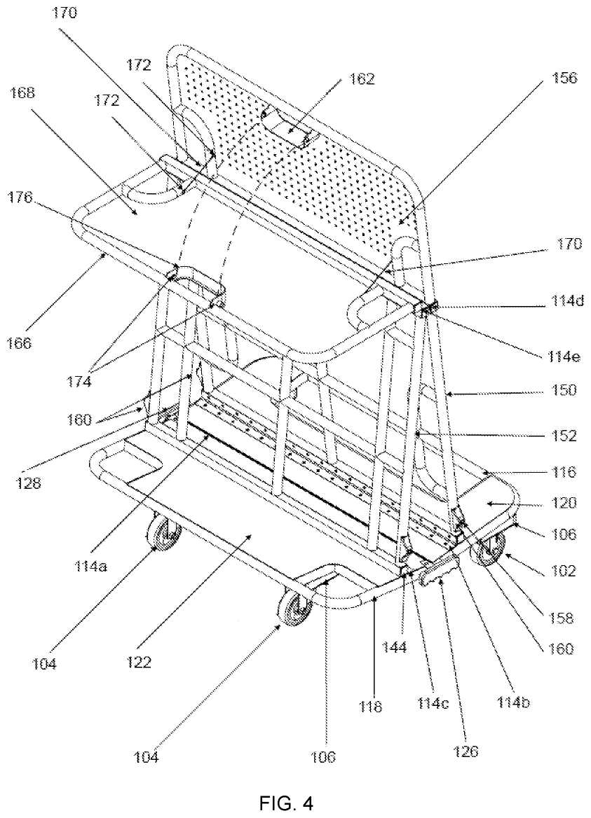

FIG. 4 is an isometric rear view of the cart 100 in the open or expanded position with the tray 164 in the open position.

Tray 164 has a rectangular shape with two rounded corners and is composed of subframe 166, sheet 168, bracket 176, and two ball nose plungers 174 which are spring loaded. Tray 164 is coupled along a long edge to subframe 152 via hinge 114e and secured to subframe 150 via two of wire lanyard 170. Wire lanyard 170 provides a mechanical limit to the open position of tray 164, and the length of wire lanyard 170 defines the angle formed between tray 164 and subframes 150, 152. Wire lanyards 170 are affixed at each end with screws 172. It is generally preferred that this angle be horizontal or parallel to the ground on which the cart 100 is operated, however, other angles are possible or desirable where the tray 164 is being used for a particular purpose where a non-horizontal orientation is needed or the cart 100 is not on level ground. Accordingly, wire lanyards 170 are adjustable in length. In the open position, tray 164 provides the aforementioned work surface. In the closed position, when both ball nose plungers 174 mate with holes in bracket 162, tray 164 together with sheet 168 provides a lid to a storage cavity formed between tray 164 and subframe 150 together with sheet 156.

Subframe 166 further provides a place for the user to grip when steering the cart 100, with the handhold in the cavity of bracket 162 or between ball nose plungers 174 at bracket 176. Ball nose plungers 174 are affixed to bracket 176.

Bracket 162 is affixed to the center of the top edge of sheet 156. Bracket 162 has a U-shape with a hole in each of the upturned portions where ball nose plunger 174 mates when tray 164 is closed. Dashed lines indicate the path tray 164 takes when closing and opening, and demonstrates the alignment between the two ball nose plungers 174 and bracket 162. Ball nose plungers 174 have a cylindrical shape with a spring inside and a ball bearing held at one end by the spring. That end of the cylinder is narrower than the diameter of the ball bearing, so the ball bearing is captured.

Pouch 178 has a rectangular shape and is mounted to sheet 156 via binding bolt 180 on the side facing tray 164. Pouch 178 can hold small goods, like tools or hardware.

FIG. 5 depicts an exploded view of the latch hardware, caster hardware, and hinge hardware. FIGS. 5A and 5B offer enhanced views of Detail A and Detail B shown in FIG. 5. Many of the elements of the latch hardware, caster hardware, and hinge hardware are discussed above to the extent that they are visible in FIGS. 1-4, and are discussed in further detail below.

Nut bar (or hinge nut bar) 154 is flat and rectangular in shape with multiple threaded holes. After a hinge nut bar is inserted in both of the tubes of subframe 116 and subframe 118 which are coupled by hinge 114a, then a screw 142 is driven through every hole in hinge 114a and through respective holes in subframe 116 or subframe 118 and into nut bar 154. The same process and structure secures the hinge 114d between subframe 150 and subframe 152 and secures the hinge 114e between subframe 152 and subframe 166.

Left latch handle 126, visible at the union of subframe 116 and subframe 118, has a flat rounded rectangular shape with rounded corners and one long edge scalloped. Two of tapered pin 130 are affixed on a flat side of left latch handle 126, and on that same side pull pin 132 is also affixed. Right latch handle 128 has a flat rounded rectangular shape with rounded corners and one long edge scalloped. Two of tapered pin 130 are affixed on a flat side of right latch handle 128, and on that same side a pull pin 132 is also affixed. Tapered pin 130 is formed as a narrow cylinder with a tapered end, and as discussed above, is affixed to both the left latch handle 126 and the right latch handle 128. Each tapered pin 130 is inserted into a bushing tube 142 when cart 100 is in the open and locked position, and each tapered pin 130 is inserted into a bushing tube 158 when cart 100 is in the folded and locked position.

Pull pin 132 has a cylindrical shape with one threaded end and with the rest of the body unthreaded or smoothed. The threaded end of pull pin 132 mates with the left latch handle 126 on one end of cart 100, and the threaded end of another pull pin 132 mates with right latch handle 128 on the other end of cart 100. Arranged around the unthreaded end of pull pin 132 is a fixed washer and a nut having a hexagonal end and a threaded exterior end. Between the fixed washer and the nut is a captive spring, with the captive spring providing tension on the pull pin such that a user may “pull” the pull pin out of its receptacle in the respective subframe and transition the cart 100 between folded (shown in FIG. 6) and unfolded positions. The nut slides on the smooth part of the pull pin 132, and the threaded end of the nut mates with pull pin housing 134. Pull pin housing 134 is installed in subframe 118. Pull pin 132 provides spring actuated retraction for left latch handle 126 and right latch handle 128.

Pull pin housing 134 is cubic in shape with a threaded hole through it and on an adjacent side is a second smaller threaded hole. Pull pin housing 134 is held in place within subframe 118 via screw 136 accepted by the smaller threaded hole. Pull pin housing 134 provides an anchor point for pull pin 132 within subframe 118.

Washer 138 provides load distribution and prevents loosening, and is used between each nut 148 and the base of sheet (or plate) 122 at each hole in sheet 122 where a screw 140 threads through the hole in sheet 122 and the hole in hinge 114c to hold hinge 114c to sheet 122. Washer 138 is also used between each nut 148 and the base of sheet 120 at each hole in sheet 120 where a screw 140 threads through that and the hole in hinge 114c to hold hinge 114c to sheet 120. Screw 140 holds hinge 114b to sheet 120 and hinge 114c to sheet 122 by threading through holes in each part and mating with nut 148. Screw 140 is also used to hold subframe 116 and hinge 114a together, mating with nut bar 154, and to hold subframe 118 and hinge 114a together, again matting with nut bar 154. Screw 140 holds subframe 150 and hinge and hinge 114d together, mating with nut bar 154. Screw 140 holds subframe 112 and hinge 114d together, mating with nut bar 154. Screw 140 holds subframe 166 and hinge 114e together, mating with nut bar 154. Finally, screw 140 is used to hold subframe 152 and hinge 114e together, mating with nut bar 154.

Bushing tube 158 is tubular in shape and about as long as it is wide, and is installed on both left and right edges near the base of subframe 150 and subframe 152. Bushing tube 158 is positioned such that each pin 130 mates with a bushing tube 158 when cart 100 is in the folded and locked position. Bushing tube cover 160 has a trapezoidal polyhedron shape with rounded edges and is placed around each bushing tube 158 with one side flush to respective subframe 150 or subframe 152. Bushing tube cover 160 prevents the protruding bushing tube 158 from catching on objects when cart 100 is in use, which may damage the bushing tube 158 itself or cause damage to interior features such as doorways. Bushing tube cover 160 further provides a smooth surface for pin 130 to slide upon and into the bushing tube 148 when a user is folding the cart.

In one aspect of the disclosure, the subframes 116, 118, 150, 152, 166 are formed from a combination of square and round aluminum tube. Gussets and handholds on the subframes are formed from the same and welded to the respective subframes. Sheets 120, 122, 156, 168 are formed from aluminum sheet and welded or fastened to the respective subframes. Hinges 114a, 114b, 114c, 114d, 114e are piano hinges running the full length of the respective hinge, and may preferably be formed from stainless steel for durability and resistance to work hardening. Bushing tubes 142, 158 are formed from brass tube for lower friction, self-lubrication, and lower hardness than the steel tapered pin 130.

In other aspects of the disclosure, the subframes 116, 118, 150, 152, 166 may be formed from steel or other metals (e.g., titanium), polymers and plastics, or fiber reinforced materials (e.g., carbon fiber, fiberglass, composite plastics). Hinges 114a, 114b, 114c, 114d, 114e may be living hinges formed from molded polymers, particularly desirable where the subframes are also polymer.

In one aspect of the disclosure, discussed above, platforms 112a, 112b fold downward. In other aspects of the disclosure, platforms 112a, 112b fold upward, which requires the latch mechanism to be modified such that more space can be created at the hinge point during folding, and the method to connect the other subframes to their respective platforms needs to be reconfigured with the hinge point on the outer base edge of the subframes, rather than the inner base edge of the subframes as depicted in FIGS. 1-6.

In one aspect of the disclosure, the elevated or “upturned” angle of the platforms 112a, 112b is achieved by coupling hinge 114a to subframe 116 and subframe 118 with a gap between the two. Here, the angle is 6.5 degrees between the “upturned” edge of the platform and the ground on which the cart 100 is operated. In other aspects of the disclosure, the same angle can be achieved with angled edges on subframes 116, 118 where they meet.

In other aspects of the disclosure, any of the platforms or subframes or sheets may have square or angled corners in an alternative to rounded corners. Any of the platforms or subframes may further be configured with specialized mounts to support glass and mirrors.

In one aspect of the disclosure, the latches pivot from the rear platform, seated in subframe 118. Latch handle 126 and latch handle 128 are scalloped bars. In other aspects of the disclosure, the latches may pivot from the front platform and be seated in subframe 116. Latch handles 126, 128 may have no scalloped edge, may have grip holes or be rounded bars, may be knobs or levers, or may be an ergonomic molded form.

In other aspects of the disclosure, telescoping tubes may be incorporated into subframes 150, 152 so that the cart 100 can vary in size or a user may adjust the pitch of the vertical subframes to better accommodate certain goods. Similarly, platforms 112a, 112b may have telescoping tubes to accommodate wider loads or narrow the cart 100 for access reasons.

In one aspect of the disclosure, the casters 102, 104 have 4-inch diameter soft rubber caster wheels. In other aspects of the disclosure, larger or smaller wheels may be used and may be formed from hard rubber, pneumatic tires with or without inner tubes, be formed from polyurethane, plastic, or other metals. Casters 102, 104 may swivel or be rigidly fixed in place. In one aspect of the disclosure, the caster 104 has a foot-operated brake. In other aspects of the disclosure, caster 102 may have a brake in conjunction with or alternatively to caster 104. In other aspects of the disclosure, casters 102, 104 may be coupled to brackets 106 via hinges such that casters 102, 104 fold outward to extend beyond the perimeter of the cart 100 and improve stability, or fold inward to nest within the respective subframe.

In other aspects of the disclosure, tray 164 may be omitted. Tray 164 may be limited in range of motion by a knife hinge, restricted angle hinge, or other type of strap from above or kickstand from below. Tray 164 may alternatively be secured in the closed position by a locking hinge, magnet, clasp, hasp, strap, clip, snap, catch, zipper, hook and loop fastener, or latch. Pouch 178 may be alternatively secured by any of those aforementioned mechanisms.

The operation of the cart is as follows:

Starting with cart 100 in the open position, as seen in FIG. 1, and tray 164 in the closed position, as seen in FIG. 6, the user may load goods onto cart 100 by resting them on platform 112a and platform 112b. Then enough goods can be placed in the area between subframe 150 and subframe 152 and resting on both platform 112a and platform 112b simultaneously. Then the user may roll cart 100 and goods via caster 102 and caster 104, applying the brake on caster 102 as needed to keep cart 100 from rolling.

The user can open tray 164 as seen in FIG. 1, provided there are no goods leaning on subframe 152 or the goods leaning on subframe 152 are short enough, by gripping the topmost edge and pulling subframe 166 apart from subframe 150, thus disengaging ball nose spring plunger 174 from cutouts in bracket 175, and allowing tray 164 to rest open, supported by hinge 114e and two of wire lanyard 170. The user can then access pouch 178, or reposition pouch 178 by loosening binding bolts 180 and re-tightening in a new perforated hole location on sheet 156. With tray 164 in the open position, the user can grip subframe 166 through the cutouts in sheet 168 to drive and steer cart 100. To close tray 164, the user lifts it to pivot along hinge 114e until the two ball nose spring plunger 174 engages with cutouts in bracket 175 and subframe 166 closes against subframe 150.

To fold cart 100 the user first unloads all goods. Then starting with either left latch handle 126 or right latch handle 128 the user pulls it horizontally from cart 100 in a direction parallel to hinge 114a, compressing the spring in pull pin 132 to its maximum travel, thus extracting both of tapered pin 130 from their respective bushing tube 142. Then while still pulled outward, the user rotates the selected latch handle by 90 degrees counterclockwise and releases, allowing pull pin 132 by spring force to retract the latch handle. Then the user pulls, rotates, and releases the other latch handle. Now all four tapered pins 130 are exposed and the latch handles are perpendicular to their original state. Next the user grips subframe 150 or subframe 152 and lifts cart 100 vertically. When the cart is lifted vertically, platform 112a and platform 112b rotate towards each other by force of gravity along the axis of hinge 114a until they come to a resting position with their bases facing. When platform 112a and platform 112b rotate towards each other, each caster 102 passes through their respective cutaways in platform 112b, and both of caster 104 pass through the cutaway in platform 112a. At this stage the user can rest cart 100 can on the ground, supported by the outer long edges of platform 112a and platform 112b. Next, the user pulls either left latch handle 126 or right latch handle 128 outward from cart 100 in a direction parallel to hinge 114a, compressing the spring in pull pin 132 to its maximum travel. Then while still pulled outward, the user rotates the selected latch handle by 90 degrees counterclockwise until both of tapered pin 130 on that latch handle align with the hole of a bushing tube 158, and release the latch handle, allowing pull pin 132 to retract the latch handle by spring force and insert each affixed tapered pin 130 into its respective bushing tube 158. Next the user repeats those steps to pull, rotate, and release the other latch handle. cart 100 is now in the folded position and secured via left latch handle 126 and right latch handle 128, as seen in FIG. 6. In the closed position the user can lift cart 100 by subframe 150 and/or subframe 152 to carry, maneuvering it as needed.

To unfold/open cart 100, starting from the folded position as seen in FIG. 6, the user first grips either left latch handle 126 or right latch handle 128 and pulls it outward horizontally from cart 100 in the direction parallel to hinge 114a, compressing the spring in pull pin 132 to its maximum travel, thus extracting both of tapered pin 130 from their respective bushing tube 158. With both taper pin 130 exposed, the user then rotates the selected latch handle 90 degrees clockwise and releases it, allowing pull pin 132 to retract the latch handle in an orientation perpendicular to the previous state and with the two tapered pin 130 exposed. Next the user repeats those steps with the other latch handle to grip, pull, rotate, and release. Then the user tips the cart 100 downward along a vertical plane which runs through hinge 114a, directing either left latch handle 126 or right latch handle 128 downward toward the ground. With cart 100 tilted on an acute angle, the weight of cart 100 pushing downward on the rounded corners of platform 112a and platform 112b causes the two platforms to travel upward and away from each other, pivoting on hinge 114a, and reaching a partially unfolded state. Then the user returns the cart to an upright position platform 112a and platform 112b rotate upward to their full range of motion and come to rest on the casters and the inner top edge of each platform touches the other. The cart is now in the open and unlocked position with left latch handle 126 and right latch handle 128 in a vertical position and all four tapered pin 130 exposed.

To lock the cart, the user first grips either left latch handle 126 or right latch handle 128 and pulls it outward horizontally from cart 100 in the direction parallel to hinge 114a, compressing the spring in pull pin 132 to its maximum travel. Then the user rotates the selected latch handle 90 degrees counterclockwise to align each tapered pin 130 with its respective bushing tube 142 and releases it, allowing pull pin 132 to retract the latch handle in a horizontal orientation, perpendicular to the previous state and with the two tapered pin 130 mated in their respective bushing 142. Next the user repeats those steps with the other latch handle to grip, pull, rotate, align, and release. The cart is now in the open position and locked.

What is claimed is:

1. A transportation apparatus comprising:
an A-frame having a first subframe, second subframe, third subframe, and a fourth subframe, the first and second subframes forming a base of the A-frame, the third and fourth subframes forming sides of the A-frame;
a first hinge mechanically coupling the first subframe to the second subframe;
a second hinge mechanically coupling the first subframe to the third subframe;
a third hinge mechanically coupling the second subframe to the fourth subframe;
a fourth hinge mechanically coupling the third subframe to the fourth subframe;
a fifth hinge mechanically coupling the third subframe to the fifth subframe, said fifth subframe adjustable between an open state and a closed state wherein said fifth subframe forms a horizontal surface in said open state and wherein said fifth subframe forms and said third subframe form a storage cavity in said closed state; and
a locking mechanism for transitioning the transportation apparatus between an expanded state and a collapsed state, the locking mechanism adjustable between an engaged state and a disengaged state.

2. The transportation apparatus of claim 1, wherein the locking mechanism has:
a handle coupled to the first hinge;
at least one tapered pin coupled to the handle, wherein the tapered pin is configured to mate with a hole in at least one of the first subframe and the second subframe, said tapered pin further configured to mate with a hole in at least one of the third subframe and the fourth subframe; and
wherein the locking mechanism transitions between the engaged state and the disengaged state in response to a force that is applied on the handle axially in a direction parallel to a length of the first hinge.

3. The transportation apparatus of claim 2, wherein the expanded state of the transportation apparatus comprises:
the locking mechanism is in the engaged state; and
the at least one tapered pin is mated with a hole in at least one of the first subframe and the second subframe.

4. The transportation apparatus of claim 3, wherein the collapsed state of the transportation apparatus comprises:
the locking mechanism is in the engaged state; and
the at least one tapered pin is mated with a hole in at least one of the third subframe and the fourth subframe.

5. The transportation apparatus of claim 4, wherein the handle as a first tapered pin and a second tapered pin on opposite ends of the handle, the first tapered pin configured to mate with either of the hole in the first subframe and the hole in the third subframe, and the second tapered pin configured to mate with either of the hole in the second subframe and the hole in the fourth subframe.

6. The transportation apparatus of claim 1, wherein the third subframe is configured to provide one or more handholds by which the transportation apparatus may be lifted.

7. The transportation apparatus of claim 1, further comprising at least one caster bracket mounted to the first subframe and at least one caster bracket mounted to the second subframe.

8. The transportation apparatus of claim 1, comprising a first caster wheel mounted to the at least one caster bracket on the first subframe and a second caster wheel mounted to the at least one caster bracket on the second subframe, wherein the first caster wheel is offset from the second caster wheel.

9. The transportation apparatus of claim 8, wherein the first subframe and the second subframe form a V-shape when the transportation apparatus is in the expanded state with the first hinge at the base of the V and closer to the ground when the transportation apparatus is in use, and wherein the at least one caster bracket is mounted at an angle relative to the first subframe or the second subframe such that, when in the expanded state, a bottom face of the caster wheel is parallel to the ground.

10. The transportation apparatus of claim 1, further comprising at least one wire lanyard mechanically coupled to the third subframe at one end of the wire lanyard and to the fifth subframe at an opposing end of the wire lanyard, wherein the wire lanyard is configured to limit the travel in the open state of the fifth subframe and the length of the wire lanyard defines the angle formed between the fifth subframe and the third subframe in the open state.

11. The transportation apparatus of claim 10, wherein the third subframe and the fifth subframe are removably attached to each other via a holding mechanism;
wherein the holding mechanism comprises a ball nose spring plunger affixed to the fifth subframe and configured to mate with the third subframe.

12. The transportation apparatus of claim 1, wherein a sheet is affixed to a surface of a subframe, said sheet perforated with a plurality of holes, and said sheet configured to provide a level surface relative to the subframe and the subframe is angled relative to gravity to support a flat good mounted on the transportation apparatus.

13. The transportation apparatus of claim 12, wherein the first subframe is coupled to a first sheet and the second subframe is coupled to a second sheet.

14. The transportation apparatus of claim 13, wherein the first sheet has a cutout configured to receive at least one of the first caster or second caster while the transportation apparatus is in the collapsed state.

15. The transportation apparatus of claim 1, wherein the locking mechanism further comprises:
a pull pin attached to the handle;
a spring removably coupled to the pull pin, said spring providing a force against the locking mechanism and retaining the locking mechanism in an engaged state;
an expanded state bushing tube coupled to at least one of the first subframe or the second subframe, said expanded state bushing tube configured to receive the tapered pin when the transportation apparatus is in the expanded state; and
a collapsed state bushing tube coupled to at least one of the third subframe or the fourth subframe, said collapsed state bushing tube configured to receive the tapered pin when the transportation apparatus is in the collapsed state.

16. A folding transportation apparatus comprising:
an A-frame mounted to a base, said base having at least one wheel; and
a second frame rotatably mounted to the A-frame, said second frame having a first position in the plane of one side of said A-frame, said second frame having a second position with a top edge of said second frame extended from the A-frame for use as a handle to move the folding transportation apparatus, wherein said second frame is rotatable between the first position and second position.

17. The folding transportation apparatus of claim 16, wherein the second frame includes a tray surface.

18. An A-frame transportation apparatus comprising:
a base having at least one wheel;
a frame having a bottom side mounted to the base;
a first subframe rigidly fixed to a top side of the frame;
a second subframe mounted to the top side of the frame via a hinge, the second frame being rotatable between a first position and a second position, wherein:
the second subframe in the first position is oriented in parallel with the first subframe;
the second subframe in the second position is oriented nonparallel to the first subframe;
the second subframe having a tray which forms a storage cavity between the first subframe and the second subframe in the first position, said second subframe having a tray providing a work surface in the second position; and
the second subframe having handles along a perimeter for maneuvering the transportation apparatus.

19. The transportation apparatus of claim 18, wherein the frame includes at least one first leg and at least one second leg, and a top end of said first leg and a top end of said second leg are rotatably attached to each other.

20. The transportation apparatus of claim 19, wherein the base comprises two halves that are collapsible along a midline of the base.
